(19) United States
(12) Patent Application Publication
(10) Pub. No.: US 2008/0263805 A1
(43) Pub. Date: Oct. 30, 2008

(54) CAMPER SHELL WINDSHIELD WIPER UNIT

(76) Inventor: Gary Sebring, Leawood, KS (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/740,793

(22) Filed: Apr. 26, 2007

(51) Int. Cl. B60S 1/04; B60P 3/377

(52) U.S. Cl. 15/250.01; 296/186.5

(57) ABSTRACT

The present invention relates to a camper shell windshield wiper, wherein the wiper unit removes precipitation or debris from a window of the truck camper shell thus allowing the driver to view unobstructed through the window. In particular, the present invention may be used to wipe or sweep the rear-window of the truck camper shell. Specifically, the unitary windshield wiper unit may include a truck camper shell, wiper arm, wiper motor, and wiper blade. The unitary windshield wiper unit may also be associated with a washer fluid reservoir, washer fluid spray nozzle, washer fluid pump, or fluid delivery tube, which may be utilized to contact washer fluid to the window to be wiped, thus removing precipitation and debris from the camper shell window in a more effective manner. The present invention is also a kit for installing a unitary camper shell windshield wiper unit.

### FIELD OF INVENTION

The present invention relates to a shell windshield wiper unit for a vehicle, specifically including a pick up truck. More particularly, the present invention is to a shell, such as a truck or camper shell, with an attached wiper motor, wiper arm, and wiper blade to sweep the rear window of the shell and accommodate the visibility needs of the driver.

### BACKGROUND OF INVENTION

A number of shells, campers, toppers, or caps for recreational vehicles have been developed in recent years. Many of these structures, collectively referred to as camper shells, have been in the form of truck shells mounted to the bed of a pick up truck or similar vehicle. Generally, these camper shells have been developed for use on pick up trucks that did not exceed the dimensions of the cab of the vehicle, and thus did not materially increase its fuel consumption. These structures have provided a number of different uses, including storage and habitation, as for example, on a camping trip.

Traditionally, pick up truck camper shells have been mounted over a pick up truck bed, and have permitted the conversion of the truck bed into a closed area. Camper shells have been typically constructed of rigid and heavy materials such as fiberglass, plastic, or metal, and have not been easily installed or removed from the truck. While a shell is usually attached with clamps and is technically removable, it is rarely removed from a vehicle once installed. One exception was when a large load had to be hauled and did not otherwise fit within the camper shell.

In many instances, the camper shells were constructed for a specific truck or line of trucks, and were not readily adaptable to fit different size truck beds. As a result, sometimes it has been necessary for the shells to be specially constructed to fit the bed of a particular pick up truck. In recent years, pick up camper shells have become quite popular and appear on the market in a variety of different shapes, models, and designs. For all of these different camper shells there have been a wide variety of installment procedures and means of affixing the camper shell to the vehicle, which are well known in the art.

Regardless of the particular model or design of camper shell, following installation, the shell was fully integrated with the vehicle. As a consequence, the windows of the camper shell became the new, de facto rear-windows of the vehicle. Despite being fully integrated with the vehicle, the camper shells in the prior art do not possess window wiper capabilities. Because precipitation and debris may accumulate on the camper shell windows and diminish the overall and rear-view visibility of the driver, the lack of a window wiper on the camper shell is considered a serious problem. In fact, the problem may, in some inclement weather circumstances, impact the safety of the camper shell users, particularly the drivers of the camper shell vehicles. As such, there exists a long-felt need to solve this problem.

Of course, wiper installations for automotive vehicles are already well known in the art, and typically involve an electromotor as well as a gearing for a swinging drive of a wiper shaft that are located in a common housing. The wiper technology for the cab of the vehicle, however, is not readily applicable to a camper shell due to several factors including: (1) durability of the camper shell, as the necessary holes or attachments are not currently pre-fabricated; (2) cost of installing an expensive feature to what is an add-on feature to a vehicle (the camper shell); and, (3) the technical savvy of associating the wiper unit with a sufficient power source and an accompanying on/off switch that is accessible to the driver of the vehicle.

Due to the high cost and difficulty of developing an effective camper shell wiper unit, this long felt need has not been satisfied. Among other barriers to development, the materials from which the camper shells are made (e.g. fiberglass, plastic, and metal) are often highly resistant to drilling and/or implementing a window wiper. Furthermore, the marginal cost of a wiper motor is relatively high in comparison to the overall cost of a camper shell. Finally, the method by which a camper shell wiper unit may be powered and supplied with wiper fluid is not readily apparent, particularly since the truck shell is structurally isolated from the cab of the vehicle. In view of the above-described shortcomings of camper shells in the prior art, there exists a need for a camper shell windshield wiper unit and a kit for installing a truck shell wiper unit. More specifically, there exists a need for a truck shell wiper unit that provides a wiper motor, wiper arm, and wiper blade. In addition, there exists a need for a wiper unit comprising a truck shell, wiper motor, wiper arm, wiper blade, washer fluid reservoir, and washer fluid pump, wherein the wiper unit is capable of removing precipitation and debris from the rear window.

### SUMMARY OF THE INVENTION

The present invention specifically addresses and alleviates the above referenced deficiencies associated with the use of camper truck shells in the prior art. The present invention is directed to a camper shell with a windshield wiper unit. The present invention is also directed to a windshield wiper unit integrally attached to a camper shell. More particularly, the present invention is directed to a unitary camper truck shell with a windshield wiper unit. The wiper apparatus of the camper shell wiper unit includes a wiper motor, wiper arm, and wiper blade to sweep the rear window of a camper truck shell. The camper shell wiper unit may further include an associated electric cable or power source. Specifically, the truck shell wiper unit operates to remove precipitation and debris buildup on the window, such as rain, dust, and snow, allowing the driver to view unobstructed through the rear window. The unit may also include a washer fluid reservoir, a washer fluid reservoir pump, a washer fluid spray nozzle, washer fluid delivery tubing, and a power switch to control the wiper motor and reservoir pump. The switch may be placed inside the cab of the vehicle, and within reach of the driver. The unit may be wired to include a delay after each time the glass is swiped. In addition, the truck shell wiper unit may also be wired to release washer fluid when the driver activates the reservoir pump switch.

More particularly, the present invention relates to a unitary truck shell wiper that may be attached to the camper truck shell through a window or, alternatively, on the frame of the camper shell. The window may be pre-fabricated with a hole or small opening to allow communication between the wiper arm and the wiper motor. Plastic tubing may also be inserted into the prefabricated opening in the camper shell window, so as to prevent the shaft of the wiper motor to contact or grind against the window. In order to preserve the integrity of the window, the window's thickness may be dimensioned to fully support the wiper motor, wiper arm, and wiper blade (collectively, the wiper apparatus). Alternatively, the truck shell wiper unit may be directly attached to the frame of the camper truck shell, such as by clamps, hooks, adhesives, screws, or any other attachment means known in the art. In one embodiment, the wiper arm is adjustable in length so as to enable the user to increase or decrease the total blade wiping area.

### BRIEF DESCRIPTION OF THE DRAWINGS

FIG. 1 is a perspective view of the camper shell windshield wiper unit (380), the camper shell itself (210) being removably attached to the bed (202) of the vehicle (200). FIG. 1, also shows a rear-window of a camper-shell (216), with the wiper arm (220) attached to the rear-window, and a wiper blade (240) attached to the wiper arm (220).

FIG. 2 is a perspective view of the camper unit, showing a rear window of a camper-shell unit on the back of a pick up truck and the attached wiper arm (220) attached to the rear-window (216) of the camper shell (210) and a washer fluid spray nozzle (224) disposed above the rear-window (216). In this picture, it is apparent the camper-shell is not part of the car (e.g. an SUV), but a structure added to the bed of the pick up truck.

FIG. 3 is a perspective view of the camper unit, showing rear window (216) of camper-shell unit (210) on the back of a pick up truck and the rear window blade. In this picture, it is evident the window wiper was added on and not part of the original vehicle or camper-shell unit.

FIG. 4 is a perspective view of the rear window (216), showing rear window (216), wiper blade (240), wiper motor (300) through the glass, and the plastic wiper fluid reservoir (260) through the glass on the far left side of the figure.

FIG. 5 is a perspective view of the rear window (216) and wiper blade (240) of the camper shell unit (210). The wiper blade (240) is attached through the fiberglass window.

FIG. 5A shows an additional embodiment where the wiper is attached to the camper shell frame, instead of through the window.

FIG. 6 is a perspective view of the camper-shell unit (210), showing rear window (216) of camper-shell unit (210) on the back of a pick up truck, and the rear window blade (240).

FIG. 7 is a perspective view of the camper-shell unit (210), showing rear window of camper-shell unit (210) open on the back of a pick up truck and also particularly showing the wiper motor (300). As previously, it also shows that the window blade (240) is attached through the window (216). There is also an electric cable extending from the wiper motor (300) along the frame of the camper, that then leads under the camper shell (210) up into the cab of the car (200) and is attached to a power source (i.e. similar to a trailer hitch power source).

FIG. 8 is a perspective view of the wiper fluid reservoir/container (260) and the associated fluid pump (280), which leads to a nozzle (218) on or near the attached wiper blade (240).

FIG. 9 is a perspective view of the wiper fluid container (260), the wiper blade motor (300). Importantly, the power source electric cables (360) are lined under the camper shell (210) as well as the wiper fluid delivery tubing (340). Below the fluid container (260), there is a hole (400) drilled into the bed of the vehicle, and in which the power cord (380) enters and travels toward the cab of the vehicle.

FIG. 10 is a perspective view of a close-up of the wiper fluid reservoir (260) with pump (280) and the associated fluid delivery tubing (340) and power cords (360).

FIG. 11 shows the power cord (360) entering the cab of the car through a hole drilled (400) into the bottom of the cab, where the cord re-emerges and attaches to a power source (420) on the front panel of the car (e.g. AC adapter). There is also the option of a power switch at that point to turn on and off the wiper blade.

### DETAILED DESCRIPTION OF THE PREFERRED EMBODIMENTS

The present invention relates to a camper shell windshield wiper unit for a vehicle (200), such that the wiper unit may remove precipitation and debris from a window of a camper shell. It is contemplated that the present invention may be used by a driver, in particular a driver within the cab of a vehicle having an attached camper shell (210), to improve visibility, such as through the rear-window of the camper shell, by wiping off rain, sleet, ice, snow, dust, dirt, or other debris. In particular, the present invention may be used for a pick up truck or any other vehicle (200) with a bed that can accommodate a camper shell (210) having a window (216). The camper shell (210) may be rigid or collapsible, and may be constructed by any materials known in the art, including but not limited to fiberglass, plastic, or metal. As used herein, the term camper shell is meant to include truck shells, campers, camper shells, caps, and toppers that may be attached to pick up trucks and other vehicles with a bed. The camper shell structure (210) will generally include a frame (410) and at least one window (216).

Specifically, the camper shell windshield wiper unit may comprise a camper shell structure (210) adapted to be mounted to the bed (202) of the vehicle (200). Typically, the camper shell will have at least one window (216), such as a rear-window. Attached to the camper shell structure is a wiper apparatus (380) with a number of components. The wiper apparatus (380) includes a wiper arm (220), a wiper motor (300), and a wiper blade (240). Generally, the wiper motor (300) is in communication with the wiper arm (220) and capable of moving the wiper arm (220) across the window (216). Furthermore, the wiper blade (240) is in communication with the wiper arm (220). In one embodiment of the present invention, the wiper arm may be swept by the wiper motor in a semicircular rotational movement, whereby the sweep degree is determined by the linkage inside the motor. Alternatively, the wiper motor may move the wiper arm across the window from top-to-bottom, left-to-right, or in any other manner known in the wiper motor art. In one embodiment, the wiper arm is moved about the axis of the wiper motor. Most wiper motors have a sweep of 90 degrees, but some motors have an adjustable sweep. The wiper motors of the present invention allows the wiper arm a sweep of at least about 80 degrees, but may allow a larger sweep up to about 180 degrees. Wiper motors used for boat wipers and automobile wipers may also be used for the present invention.

In an additional embodiment, the camper shell wiper unit of the present invention may involve more than one wiper motor, more than one wiper arm, more than one wiper blade, or any combination thereof. In particular, the wiper unit may include two separate wiper motors that are in communication with two different wiper arms, which are respectively in communication with two distinct wiper blades. In such a configuration, two prefabricated holes may be placed at the top of the camper shell rear-window, the holes being level with one another, and separated by approximately ⅓ of the horizontal length of the window. The camper shell window may be specially ordered from glass manufacture to posses the desired prefabricated holes. This configuration may be particularly desirable since it allows for greater surface area sweep of the window by the present invention. The wiper motors, wiper arms, and attached wiper blades may also be positioned at the bottom, sides, or any other location on or near the window that allows moving of the blade across the surface of the window. Optionally, the separate motors in communication with distinct wiper arms may be configured so that their motion is harmonized in direction of movement, timing, and/or speed. The wiper motors may also be operatively connected to the same electric wiring and drawing current from the same power source within the vehicle. Moreover, one or more washer fluid spray nozzles may also be utilized in the present invention, and may be configured to spray from the frame of the camper shell or from the wiper arm. The washer fluid spray nozzles may be attached anywhere on the camper shell or wiper arm, wherein the configuration allows the nozzles to spray fluid onto the exterior window surface and not obstruct the motion of a wiper arm or wiper blade. In particular, the washer fluid spray nozzles may also be configured to spray at the same or different areas of the camper shell window.

While the wiper arm may be adjustable to increase or decrease the total length of the wiper arm, the wiper blade will be dimensioned to substantially contact the exterior surface of the camper shell window. In particular, the wiper blade will be capable of evenly sweeping the window without missing any significant areas or causing undesirable streaks. The size of the window will be used to determine the appropriate size of the wiper blade. Longer wiper blades will be utilized for shells that have larger windows, to accommodate the largest visibility area. The wiper blades used for the present invention are similar to automobile blades and are available in auto parts stores. The wiper fluid used in the wiper fluid reservoir may comprise water, freeze-resistant liquids, or any wiper fluid commonly used in association with automobile or boat wipers.

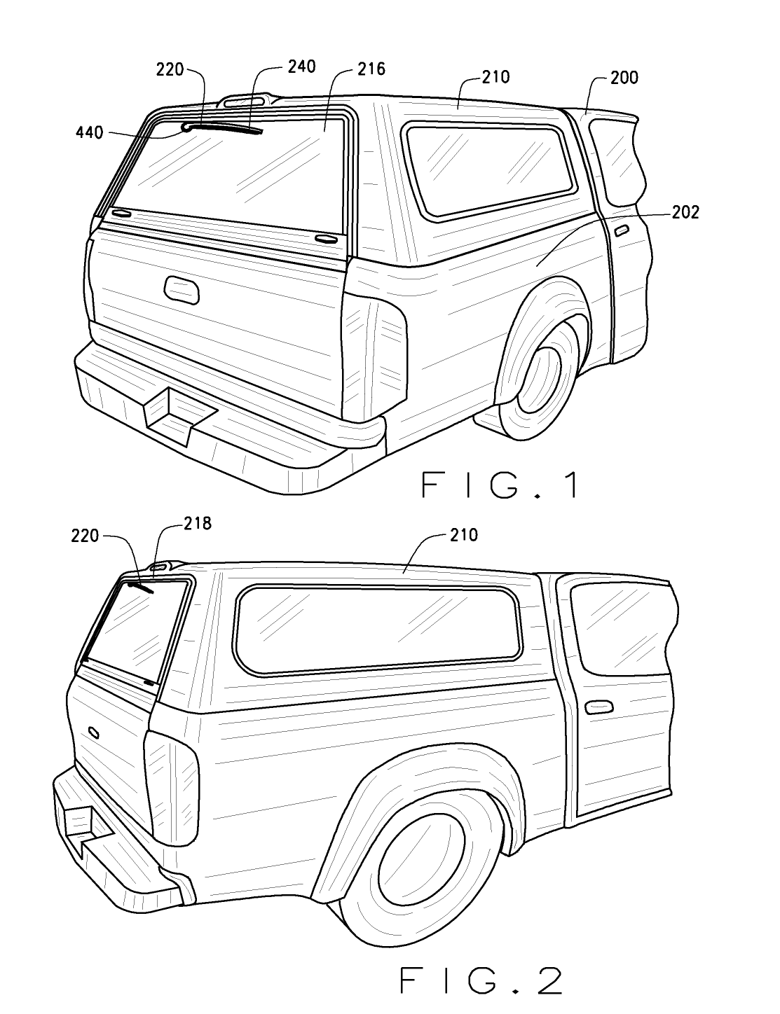

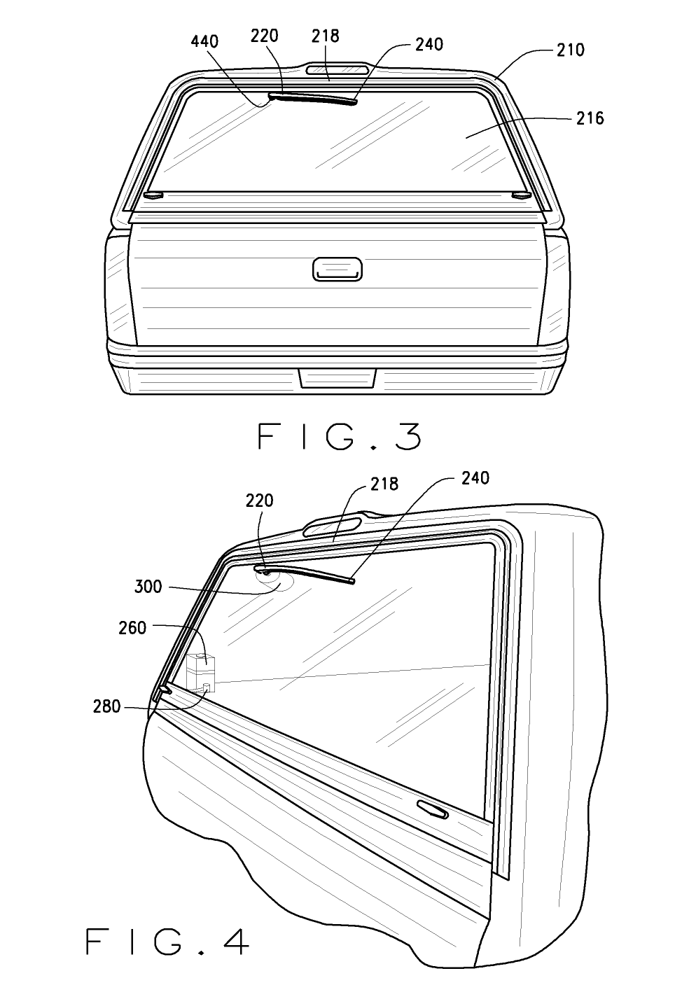

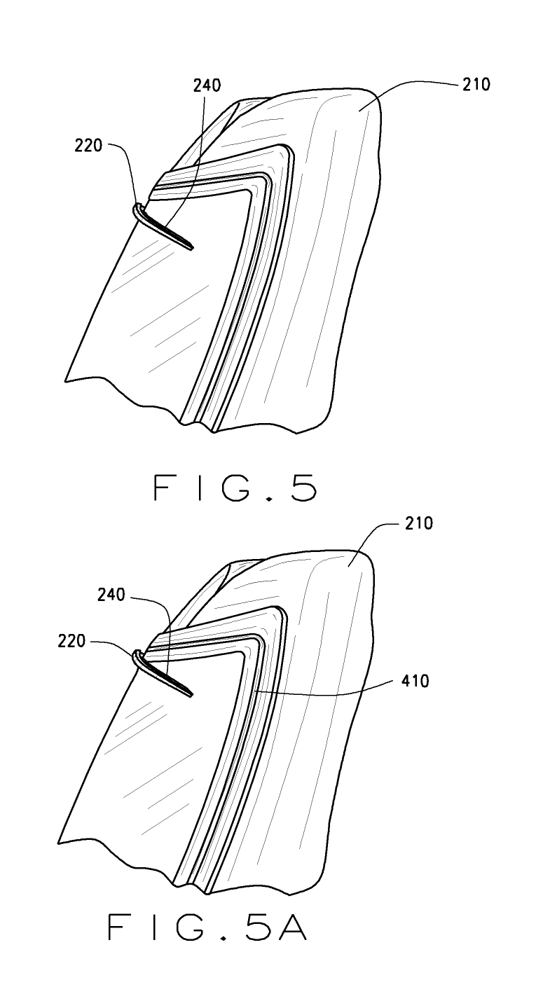

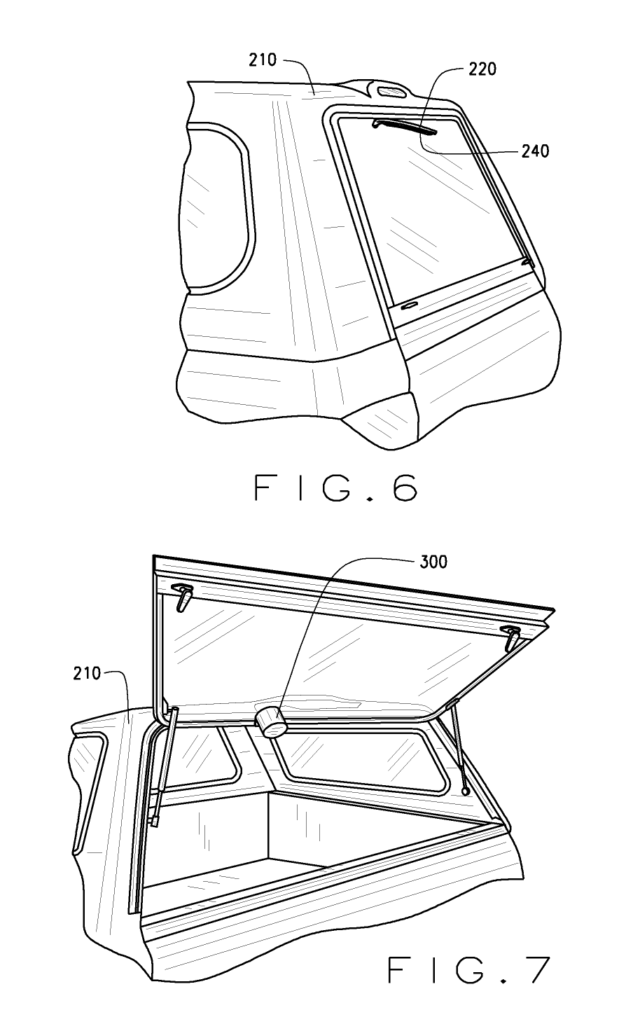

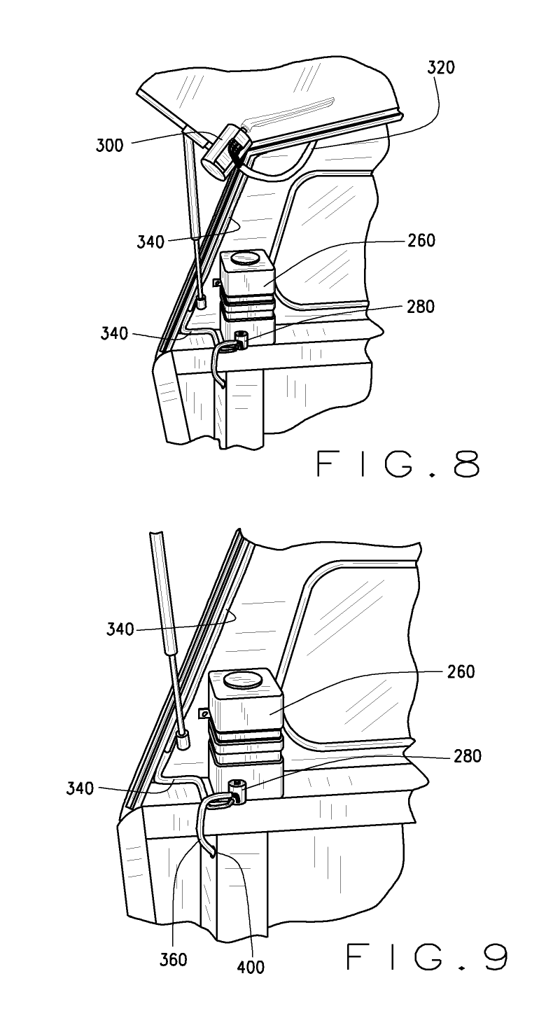

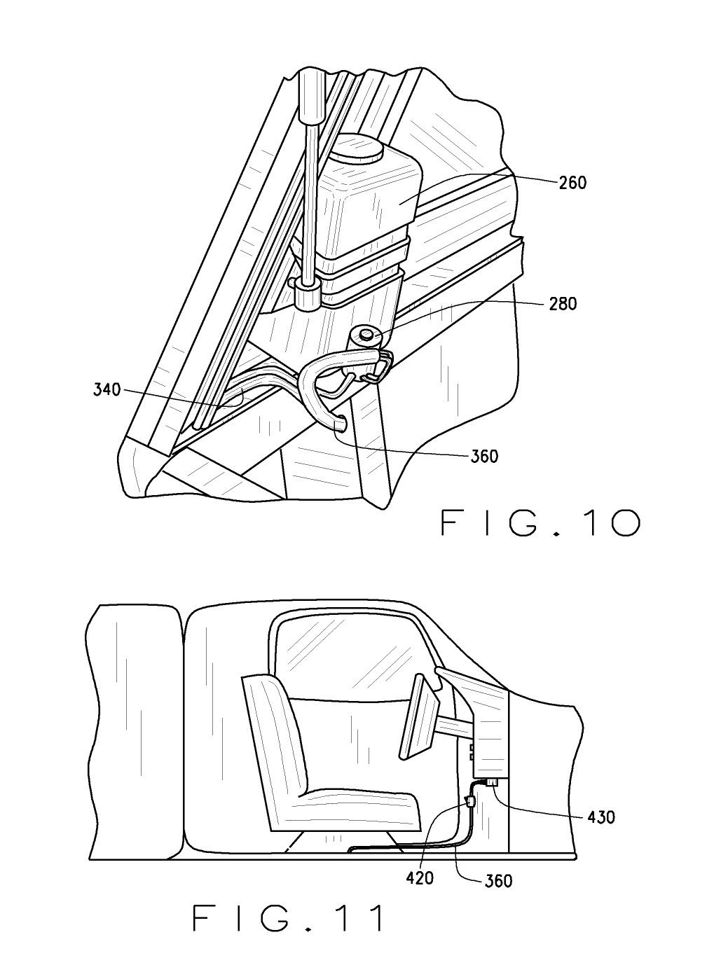

In one embodiment, the camper shell windshield wiper unit will comprise a camper shell window that is specially designed and fabricated to possess a unique hole (440) or opening in the window that can accommodate attachment of the wiper arm and wiper motor. For example, the prefabricated hole (440) in the camper shell window may be ½ inches in diameter and ordered directly from the glass manufacturer, such that this hole (440) may be added early in the fabrication process by the glass manufacture (e.g. utilizing special molding or drilling techniques). Ordinarily, in the event there is only a single wiper motor, the prefabricated hole (440) or opening will be centrally located at the top of the window, as shown by the wiper arm attachment at the pivot in the accompanying FIG. 1. In alternative embodiments, the hole may be centrally located at the bottom of the window. Similarly, the prefabricated hole may be placed in any location or configuration that allows the wiper to be in communication with the exterior surface of the window. After the unique camper shell window is fabricated, it is then tempered and sent for framing in accordance with the dimensions of the camper shell. Among other features, the camper shell window and accompanying frame may have locking devices, pistons, and hinges for installation into the camper shell. It is important to note that the hole (440) or opening in the camper shell window must be specially ordered and incorporated by the glass manufacturer, because camper shell windows do not ordinarily possess any such holes. Moreover, after the glass is tempered, it cannot be effectively drilled without shattering the glass. As such, the conventional manufacturing of camper shells as well as their tendency to resist drilling and shatter under pressure are two problems overcome by the present invention.

An individual or specialized installer (e.g. a car dealership or camper shell manufacturer) may then mount the wiper motor through the hole or opening in the window of the camper shell. In order to reduce stress on the camper shell window and firmly secure the wiper motor to the window surface, a rubber washer may be positioned between the wiper motor and the interior surface of the camper shell window. Similarly, a rubber washer may also be positioned in between the wiper arm and the exterior surface of the camper shell window. Accordingly, the wiper arm and wiper motor may be in communication with one another through a double shafted bolt, wherein the wiper motor and wiper arm are separated by a rubber washer, the camper shell window pane, and a second rubber washer. In this arrangement, the wiper arm is on the outside surface of the window, the wiper motor on the interior surface of the window, and the wiper motor is in contact with the wiper arm through the hole in the window (e.g. through the double shafted bolt). In particular, an additional feature of the windshield wiper unit may include a plastic sleeve, which is mounted on the inside of the glass hole to prevent the motor shaft from coming in contact with the glass.

As provided above, the wiper arm is in communication with the motor, and a wiper blade is connected to the wiper arm. The wiper arm may have an adjustment that allows the arm to extend from about 12 inches to about 15 inches. The wiper motor is also capable of functioning on an intermittent power supply. The intermittent feature of the wiper motor requires a relay or control circuit that may be mounted near the switch. In effect, the relay or control circuit modulates the current sent to the wiper motor, thus causing a delay and providing the intermittent wiping. More particularly, the relay or control circuit may be mounted or attached near the switch, out of view in the lower dash area. The intermittent feature may also be accomplished by any devices known in the art, including but not limited to the use of one or more switches and either a continuously variable resistor (potentiometer) or discretely selected resistors, arranged in an RC (resistor-capacitor) timing circuit, or a digital timing circuit. It is also contemplated that the relay or control circuit may also be added into the truck by the truck manufactures or car dealerships, and in the process fully incorporating the power source and power controls of the camper shell windshield wiper unit into the vehicle's computer system. In this additional embodiment, the switch and intermittent feature are built into the truck as an add-on feature to the turn signal arm. Furthermore, the present invention may also be combined with other technologies known in the art such as moisture sensors that detect moisture and automatically turn on, turn off, and modulate the appropriate wiping speed. Similarly, the present invention may also be combined with wiper arm heaters or wiper fluid heaters that are effective at melting snow or ice on the windshield, wiper arm, or wiper blade.

In an additional embodiment, an individual may mount a washer fluid reservoir (260) and an associated washer fluid pump (280) on the inside shell. In particular, the washer fluid reservoir and pump may be attached to a metal bracket that is affixed to the bed of the vehicle (i.e. drilling screws into the vehicle bed to mount the metal bracket). At this point, electric cables or wiring (320) may also be connected from the wiper motor and the washer fluid pump to a power source. Typically the power source will be located on the interior cab of the vehicle. Generally, the power source will draw an electric current from the vehicle's battery and will be controlled by a power switch that may be turned on or off, thus modulating when the wiper motor and washer fluid pump are turned on. The electric cable connecting the wiper motor to a power supply may be attached from the reservoir area and around the window frame, usually above, up to the motor. Similarly, the fluid delivery tubing is connected to the washer fluid reservoir and washer fluid pump structure with the washer fluid spray nozzle (218). The fluid spray nozzle may be attached to the wiper arm or to the camper shell structure, either configuration allowing the nozzle to spray the camper shell window with wiper fluid before or during the windshield wiper sweeping movement. The electrical mating connector of the electric cable (320) (alternatively referred to as a wire, electric wire, or power cable) is attached to another wire that is run through the bed wall of the vehicle or truck, as the back side, near the tail light access point. Typically the wall of the vehicle bed, such as pick up truck bed, is double walled, so the wire is run through the bottom of the fender underneath the truck. In particular, the wires may be run under the truck or vehicle, attached to the existing wire harness with ties, tight enough to inhibit sagging. As such, wire may be attached to an existing wire harness, and then drawn forward below the driver's seat, up through the floor and beneath the carpet, and connected to the location of the switch and the power source, such as an AC outlet. Specifically, the electrical connectors allow unplugging of the electrical wires for shell removal, without having to cut or re-splice the wiring.

In one embodiment, one switch will operate the wiper motor and the pump. Most trucks have “knock outs” for switches placed there for future accessories. The switch utilized in the present invention is automobile in type and coordinates with the “knock out.” In such an arrangement, an individual may remove the “knock out” and push in the switch. Furthermore, the switch has built in clamps on the sides to snap into the opening left by a knockout. In this regard, the camper shell windshield wiper unit is occupying a previously empty position in the vehicle's fuse box and is capable of drawing power from the vehicle's battery.

In an alternative embodiment, the wiper apparatus comprising the wiper arm, wiper motor, and wiper blade may be attached to the camper shell at the frame instead of the window. Attachment of the wiper assembly may be accomplished via drilling, screws, clamps, hooks, adhesives, or any other attachment means known in the art. This particular embodiment is display in FIG. 5A. Thus, in this embodiment, the wiper apparatus is attached to the frame of the camper shell structure.

The present invention also provides a kit for installing a camper shell windshield wiper unit. The kit includes a wiper motor, wiper arm, and wiper blade. The wiper arm may also include a hinge. In particular, the wiper arm with a hinge may be utilized when the wiper arm is installed to the frame of the camper shell, so as to prevent damage to the wiper arm when the rear window or hatch of the camper shell is opened. In an additional embodiment, the kit may further include a washer fluid reservoir with pump, power switch, wiper fluid spray nozzle, and a plastic sleeve for mounting the wiper arm and motor onto the window. Optionally, the kit may further include wire, fluid tubing, tires, connecters, fuse holder, and a fuse. In another embodiment, the camper shell wiper kit may comprise the following components: a wiper arm, wiper motor, washer fluid reservoir, washer fluid pump, and washer fluid spray nozzle. Additionally, the kit may include a wiper arm, a wiper motor, and a window of a predetermined dimension to fit a camper shell frame, the window having a prefabricated opening (410) that allows attachment of the wiper arm to the wiper motor through the opening. A set of instructions for assembling the camper shell windshield wiper unit may optionally be added to any camper shell windshield wiper kit. Fluid delivery tubing, electric cables, ties, and connecters may also be added as optional components to any kit for installing the camper shell windshield wiper unit. Thus, the present invention overcomes cost-related problems associated with buying individual components as well as the technological barrier problems. In short, the present invention satisfies a long-felt need by providing the necessary instructions to combine the wiper components in a manner where they will actually work and function on the camper shell, but in harmony with the structurally separate vehicle.

Even though the wiper arm, wiper blade, and wiper motor may be similar or commensurate (e.g. dimensions, materials, adapted to the same voltages) with those used for automobiles or boats, the wiper unit of the present invention must be installed in a different manner than wipers in the prior art. In particular, wiper units in the prior art are not installed through the windshield, due to the difficulty associated with cracking or shattering the glass. Furthermore, because the camper shell unit is structurally discrete from the power supply and wiper fluid apparatus of the vehicle, until now it has been unclear how automobile or boat components of the prior art could be combined to create the present invention. In particular, to install the camper shell windshield wiper unit, an individual must attach or mount the wiper arm in communication with the wiper motor. Where the prior art offers no suggestion to solve this problem, one embodiment of the present invention solves this problem by making a unique kind of camper shell window. In particular, this problem may be solved by mounting the wiper arm and wiper motor to a specially prefabricated camper shell window with a hole, such that the wiper arm and wiper motor are in communication through the hole in the glass window (e.g. a ½ inch diameter hole, specifically ordered from the glass manufacturer). A plastic sleeve may be placed in the hole and configured to protect the glass from grinding, damaging, or cracking the glass. The hole may also be filled with sealants such as silicone to strengthen the attachment of the wiper arm or wiper motor to the window. Similarly, the wiper arm or wiper motor may also be supported by adhesives or clips (e.g. alligator clips), in addition to the structural support provided by the window. Moreover, a hole will be drilled in the bed of the vehicle and in the floor of the vehicle cab to permit a wire to be run from the wiper motor to the power switch (e.g. power supply) in the cab of the vehicle. The path of the wire will run under the truck, and be attached in a manner to avoid sagging (e.g. attaching to the harness). Methods and procedures commonly used to connect a trailer hitch to a vehicle, in particular to a power source in the cab of a vehicle, may also be utilized in connecting a wire from the wiper motor to a switch in the cab of the vehicle. The wire may also be attached by ties and clips to the camper shell, the bed of the truck, under the truck, or within the cab of the vehicle to prevent the wire from being unexpectedly disconnected.

It is contemplated that the kit may be sold to camper shell manufacturers, auto dealerships, auto parts retailers, and any other entities or businesses that sell auto parts. As such, the kit may also be sold directly to consumers. One embodiment of the kit sold to consumers may comprise a wiper arm with a hinge, a wiper motor, a wiper blade, wiring that extends at least about the length from the camper shell rear window up to cab of the vehicle, and a power switch. The kit may optionally include a prefabricated camper shell window with a hole, which accommodates attachment of the wiper arm to the wiper motor. In the configuration where the kit also includes the prefabricated window with the hole, the end-consumer may install the wiper unit by the same procedures and manner as described above. In particular, the wiper arm will be in communication with the wiper motor through the hole in the camper shell window, and the wiper blade will be attached to the wiper arm. In this configuration, the wiper arm and blade will also be in communication with the camper shell window, and capable of sweeping precipitation or debris from the surface of the window. A plastic sleeve may also be inserted into the prefabricated hole to prevent the wiper motor from grinding, damaging, or shattering the window. The wiper arm will be in communication with the wiper motor by methods known in the art, and the wiper arm and wiper motor may be additionally supported by clips, adhesives, or sealants (e.g. silicone). In such a manner, the communication between the wiper arm and wiper motor may also be structurally supported by the window itself.

If the kit of the present invention does not include the prefabricated camper shell window with a hole, the consumer may install the wiper unit to the frame of the camper shell, since an ordinary camper shell window will shatter or crack if impacted, such as by a drill. The wiper apparatus may be installed to the frame of the camper shell by a number of different methods, including but not limited to screws, adhesives, clips, clamps, or hooks, provided that the configuration firmly attached the wiper arm in communication with the wiper motor, and the wiper arm and blade are in communication with the window of the camper shell to be wiped. Generally, the wiper apparatus may be attached to the frame of the camper shell, if the frame is wide enough to support the wiper apparatus and not damage or crack the camper shell window or camper shell body. It should be noted that these installment procedures are substantially different than those in the prior art. Here, because of the structural difference in the camper shell as compared to the vehicle, there are a different set of considerations (e.g. cracking the window or camper shell frame). For example, one potential location for drilling a hole into the camper shell frame and attaching the wiper unit may be just above the top center of the camper shell window, as displayed in FIG. 5A. As stated above, the wiper arm may also have a hinge. In such an embodiment the wiper arm may be folded or withdrawn from the window surface. Specifically, such a hinged wiper arm would may also be utilized if the wiper arm would otherwise impede opening of the rear-window or hatch of the camper shell. Accordingly, the consumer may drill holes in the camper shell frame, attach the wiper arm with a hinge to a wiper motor, and attach the wiper blade to the wiper arm in a manner commensurate with the methods previously described for the kit with a prefabricated hole.

In another embodiment, the present invention is also a camper shell wiper unit comprising: a camper shell window with a prefabricated hole, whereby the prefabricated hole is dimensioned to permit the mounting of a wiper arm and wiper motor. In an additional embodiment, the wiper unit may further comprise: a wiper arm, and a wiper motor, wherein the wiper arm and wiper motor are in communication through the prefabricated hole. In an additional embodiment, the camper shell window may be attached to a camper shell frame. Optionally, the caper shell structure may be mounted on a vehicle.

The invention illustratively disclosed herein suitably may be practiced in the absence of any element which is not specifically disclosed herein. It is apparent to those skilled in the art, however, that many changes, variations, modification, other uses, and applications to the camper shell windshield wiper unit are possible, and also such changes, variations, modifications, other uses, and application which do not depart from the sprit and scope of the invention are deemed to be covered by the invention, which is limited only by the claims which follow.

What is claimed is:

1. A camper shell windshield wiper unit for a vehicle, the unit comprising:
(a) a camper shell structure configured to be contacted to the bed of the vehicle, whereby the shell structure includes a window;
(b) a windshield wiper apparatus attached to the camper shell structure, the wiper apparatus comprising:
(i) at least one wiper arm;
(ii) at least one wiper motor, wherein the wiper motor is in communication with the wiper arm and capable of sweeping the wiper arm across the window; and,
(iii) at least one wiper blade is connected to the wiper arm.

2. The camper shell windshield wiper unit of claim 1, wherein the wiper apparatus is attached to the window of the camper shell structure.

3. The camper shell windshield wiper unit of claim 1, wherein the wiper apparatus is attached to the frame of the camper shell structure.

4. The camper shell wiper unit of claim 1, further comprising an electric cable in connection between the wiper motor and a power source in the vehicle.

5. The camper shell wiper unit of claim 1, further comprising a switch, whereby the switch is located in the cab of the vehicle and configured to control the power supply of the wiper motor.

6. The camper shell windshield wiper unit of claim 2, wherein the window is a rear-window of the camper shell structure.

7. The camper shell windshield wiper unit of claim 2, wherein the wiper arm is located outside the interior of the camper shell structure and in communication with the outside surface of the camper shell structure window, the wiper motor is located inside the interior of the camper shell structure, and the wiper motor is in communication with the wiper arm through an opening in the window.

8. The camper shell windshield wiper unit of claim 2, wherein the wiper arm is located outside the interior of the camper shell structure and in communication with the outside surface of the camper shell structure window, the wiper motor is located inside the interior of the camper shell structure, and the wiper motor is in communication with the wiper arm through a prefabricated hole in the window.

9. The camper shell windshield wiper unit of claim 1, further comprising a washer fluid spray nozzle in connection with a washer fluid reservoir and washer fluid pump.

10. The camper shell windshield wiper unit of claim 9, wherein the washer fluid spray nozzle is attached to the camper shell structure and is aligned to spray washer fluid on the camper shell structure window.

11. The camper shell windshield wiper unit of claim 9, wherein the washer fluid nozzle is attached to the wiper arm and is aligned to spray washer fluid on the camper shell structure window.

12. A camper shell wiper unit for a vehicle, the unit comprising:
(a) a camper shell structure configured to be contacted to the bed of the vehicle, whereby the shell structure includes a window;
(b) a wiper arm in communication with the window of the camper shell, whereby the length of the wiper arm may be adjustably increased or decreased;
(c) a wiper motor in communication with the wiper arm, and capable of rotary movement of the wiper arm of at least about 80 degrees;
(d) a wiper blade in communication with the wiper arm, and in which the wiper blade is of a predetermined size and shape to effectively remove precipitation and debris from the window; and,
(e) a washer fluid reservoir, the washer fluid reservoir attached to a washer fluid pump and in association with tubes leading to a washer fluid spray nozzle that is configured to spray the window.

13. A kit for installing a camper windshield shell wiper unit comprising:
(a) a wiper arm;
(b) a wiper motor; and
(c) a wiper blade.

14. The kit for installing a camper shell windshield wiper unit of claim 13, wherein the wiper arm of (a) includes a hinge.

15. The kit for installing a camper shell windshield wiper unit of claim 13, further comprising:
(d) a washer fluid reservoir,
(e) a washer fluid pump; and
(f) a washer fluid nozzle.

16. The kit for installing a camper shell windshield wiper unit of claim 13, further comprising a window of a predetermined dimension to fit a camper shell frame, the window having a prefabricated opening that allows integral attachment of the wiper arm to the wiper motor through the prefabricated opening.

17. The kit for installing a camper shell windshield wiper unit of claim 13, further comprising a set of instructions for assembling the camper shell windshield wiper unit.

18. The kit for installing a camper shell windshield wiper unit of claim 13, further comprising washer fluid delivery tubing dimensioned to connect the wiper fluid spray nozzle and the wiper fluid reservoir, and electric wire extending at least about from the rear window of the camper shell to the cab of the vehicle.

19. The kit for installing a camper shell windshield wiper unit of claim 13, further comprising ties and connectors.

20. A unitary camper shell windshield wiper unit comprising: a wiper arm attached to a camper shell, wherein the wiper arm is driven by a wiper motor capable of sweeping the wiper arm at least about 80 degrees, the wiper arm being connected to a wiper blade, whereby at least one washer fluid spray nozzle is disposed on a the camper shell, the spray nozzle communicating with a washer fluid spray tube to a washer fluid pump.

21. A camper shell windshield wiper unit comprising: a camper shell window with a prefabricated hole, whereby the prefabricated hole is dimensioned to permit the mounting of a wiper arm and wiper motor.

22. The camper shell windshield wiper unit of claim 21, further comprising: a wiper arm, and a wiper motor, wherein the wiper arm and wiper motor are in communication through the prefabricated hole.

23. The camper shell windshield wiper unit of claim 21, wherein the camper shell window is removeably attached to a camper shell frame.
